(19) United States
(12) Patent Application Publication
(10) Pub. No.: US 2010/0085505 A1
(43) Pub. Date: Apr. 8, 2010

(54) FITTING, HOT CATHODE LAMP HAVING THE FITTING, AND LIQUID CRYSTAL DISPLAY DEVICE

(76) Inventors: Hiroki Kitagawa, Shiga (JP); Shiro Iida, Kyoto (JP)

Correspondence Address: SNELL & WILMER L.L.P. (Panasonic), 600 ANTON BOULEVARD, SUITE 1400, COSTA MESA, CA, 92626, US

(21) Appl. No.: 12/442,703

(22) PCT Filed: Sep. 21, 2007
(86) PCT No.: PCT/JP2007/068377

§ 371 Date: Mar. 24, 2009

(30) Foreign Application Priority Data
Sep. 28, 2006 (JP) 2006-265543

(51) Int. Cl. G02F 1/1335; H01J 5/48; H01R 33/02

(52) U.S. Cl. 349/61; 313/318.02; 439/227

(57) ABSTRACT

A base for attaching to at least one end of a glass tube (12) that has two air-tight sealed ends, the at least one end having a remaining exhaust tube (38) that extends in a tube axis X direction of the glass tube, the base comprising: a base body (46) that is in a shape of a bottomed tube including a tubular part (42) and a bottom part (44), and receives the at least one end; and a pair of base pins (48, 50) that have been disposed upright on the base body (46), wherein the base body (46) has a housing part (52) that has been disposed in a center of the bottom part (44) so as to project in the tube axis X direction, and houses at least part of the remaining exhaust tube (38), and the base pins (48, 50) have been disposed upright on the bottom part (44) in substantially parallel to the tube axis X direction such that the housing part (52) is located between the base pins (48, 50).

### TECHNICAL FIELD

The present invention relates to a base or the likes, and in particular to a base for a hot cathode discharge lamp whose airtight-sealed glass tube has an exhaust tube, which has been used for manufacturing of the airtight-sealed glass tube and is left after the manufacturing.

### BACKGROUND ART

Conventionally, a hot cathode fluorescent lamp, a type of hot cathode discharge lamps, has been widely used as a lighting apparatus for general use, such as for room lighting. Meanwhile, recently it has been considered to use a hot cathode fluorescent lamp as a light source of a backlight unit in liquid crystal display apparatuses. As the light source of the backlight unit, a cold cathode fluorescent lamp has been mainly used. However, as the size of the liquid crystal display apparatuses increases, it is desired to use the hot cathode fluorescent lamp as an alternative to the cold cathode fluorescent lamp, because the hot cathode fluorescent lamp has an advantage over the cold cathode fluorescent lamp in terms of cost and luminous efficacy.

Regarding the liquid crystal display apparatus, it is important to make the side frames of the display narrow as much as possible to realize a compact design.

An end part of the hot cathode fluorescent lamp, that is, a part from the electrode coil to the base, is hidden behind the side frames. If the base length can be shortened, it is possible to make the side frames narrow accordingly.

The conventional structure of the base of the hot cathode fluorescent lamp is such that a pair of base pins is set up on the bottom of the base body, which is in the shape of a cylinder with a closed end, and extends to the outside in parallel. Two bases, each having the stated structure, are separately attached to each of the two opposite ends of the airtight-sealed glass tube. On at least one end of the glass tube, a part of the exhaust tube used for the manufacturing remains. The remaining exhaust tube extends from the sealed part in the same direction as the tube axis.

By inserting the glass tube into the bases as far as possible, the entire length of the hot cathode fluorescent lamp can be shortened, and the required length of the base can also be shortened. However, because of the presence of the remaining exhaust tube, the base cannot be put any farther when the top of the remaining exhaust tube comes into contact with the bottom of the base.

In the conventional technique for the hot cathode fluorescent lamp as a general lighting, the entire length of the remaining exhaust tube is reduced by about 2 to 3 mm in such a way where the remaining exhaust tube is soften by heating and then the top of the remaining exhaust tube is pressed. By means of this technique, the entire length of the base is reduced, and so does the entire length of the hot cathode fluorescent lamp.

Patent document 1: Japanese Laid-open Patent Application Publication No. 2003-308806

Patent document 2: Japanese Laid-open Utility Model Application Publication No. S55-146659

Patent document 3: Japanese Laid-open Utility Model Application Publication No. S55-148157

### DISCLOSURE OF THE INVENTION

### Problem to be Solved by the Invention

However, there is a limit on the degree of the length reduction of the remaining exhaust tube. If pressed too much, the remaining exhaust tube gets a hole. It is extremely difficult to completely eliminate the length of the exhaust tube, and it cannot be avoided that a part of the exhaust tube is left standing out.

In terms of the problem above, the object of the present invention is to provide a base that is to be attached to an end of the airtight-sealed glass tube having the remaining exhaust tube and has a further reduced length. The present invention also aims to provide a hot cathode discharge lamp and a liquid crystal display apparatus having the same.

### Means to Solve the Problem

In order to achieve the object above, the present invention provides a base for attaching to at least one end of a glass tube that has two air-tight sealed ends, the at least one end having a remaining exhaust tube that extends in a tube axis direction of the glass tube, the base comprising: a base body that is in a shape of a bottomed tube including a tubular part and a bottom part, and receives the at least one end; and a pair of base pins that have been disposed upright on the base body, wherein in an attached state, basal ends of the base pins are closer to a center of the glass tube in the tube axis direction than a tip of the remaining exhaust tube.

### Advantageous Effects of the Invention

With the stated structure, the entire length of the base can be shorter than the conventional one at least by the length between the basal ends of the base pins and the top of the remaining exhaust tube measured in the direction of the glass tube axis.

The base body may have a housing part that has been disposed in a center of the bottom part so as to project in the tube axis direction, and houses at least part of the remaining exhaust tube, and the base pins may have been disposed upright on the bottom part in substantially parallel to the tube axis direction such that the housing part is located between the base pins.

With the stated structure, regarding the base whose base pins are disposed in parallel to the glass tube axis, the entire length of the base can be shorter than the conventional one at least by the length between the basal ends of the base pins and the top of the remaining exhaust tube measured in the direction of the glass tube axis.

Alternatively, the base body may have a pair of holes that have been provided in a direction that intersects with the tube axis direction so as to be closer to the center of the glass tube than the tip of the remaining exhaust tube, and the base pins may have been implanted into the holes respectively.

With the stated structure, the entire length of the base can be shorter than the conventional one at least by the length of the parts of the base pins exposed from the base body.

### BRIEF DESCRIPTION OF THE DRAWINGS

FIG. 1A is a front view of a hot cathode fluorescent lamp pertaining to the embodiment 1;

FIG. 1B is a left-side view of the hot cathode fluorescent lamp of the embodiment 1;

FIG. 1C is a bottom view of the hot cathode fluorescent lamp of the embodiment 1;

FIG. 1D is a perspective view of a second base;

FIG. 2 is a cross-sectional view of the hot cathode fluorescent lamp of the embodiment 1 along the line A-A shown in FIG. 1C;

FIG. 3 is a perspective view showing a modification example of the second base;

FIG. 4A is a front view of a hot cathode fluorescent lamp pertaining to the embodiment 2;

FIG. 4B is a left-side view of the hot cathode fluorescent lamp of the embodiment 2;

FIG. 4C is a partly-sectioned bottom view of the hot cathode fluorescent lamp of the embodiment 2.

FIG. 4D is a perspective view of a second base;

FIG. 5 is a cross-sectional view of the hot cathode fluorescent lamp of the embodiment 2 along the line D-D shown in FIG. 4C;

FIG. 6 is a perspective view showing a modification example of the second base; and

FIG. 7 is an exploded perspective view showing a structural outline of a liquid crystal display apparatus pertaining to the embodiment 3.

### DESCRIPTION OF REFERENCE NUMERALS

10, 100 hot cathode fluorescent lamp
12 glass tube
38 remaining exhaust tube
40, 104 second base
42, 56, 112, 132 tubular part
44, 58, 114, 134 bottom part
46, 60, 110, 136 base body
48, 50, 64, 66, 120, 122, 142, 144 base pin
48A, 50A, 120A, 122A basal end
300 liquid crystal display apparatus
302 liquid crystal screen unit
304 backlight unit

### BEST MODE FOR CARRYING OUT THE INVENTION

The following describes the embodiments of the present invention with reference to the drawings. A hot cathode fluorescent lamp, a type of a hot cathode discharge lamp, is taken as an example.

### Embodiment 1

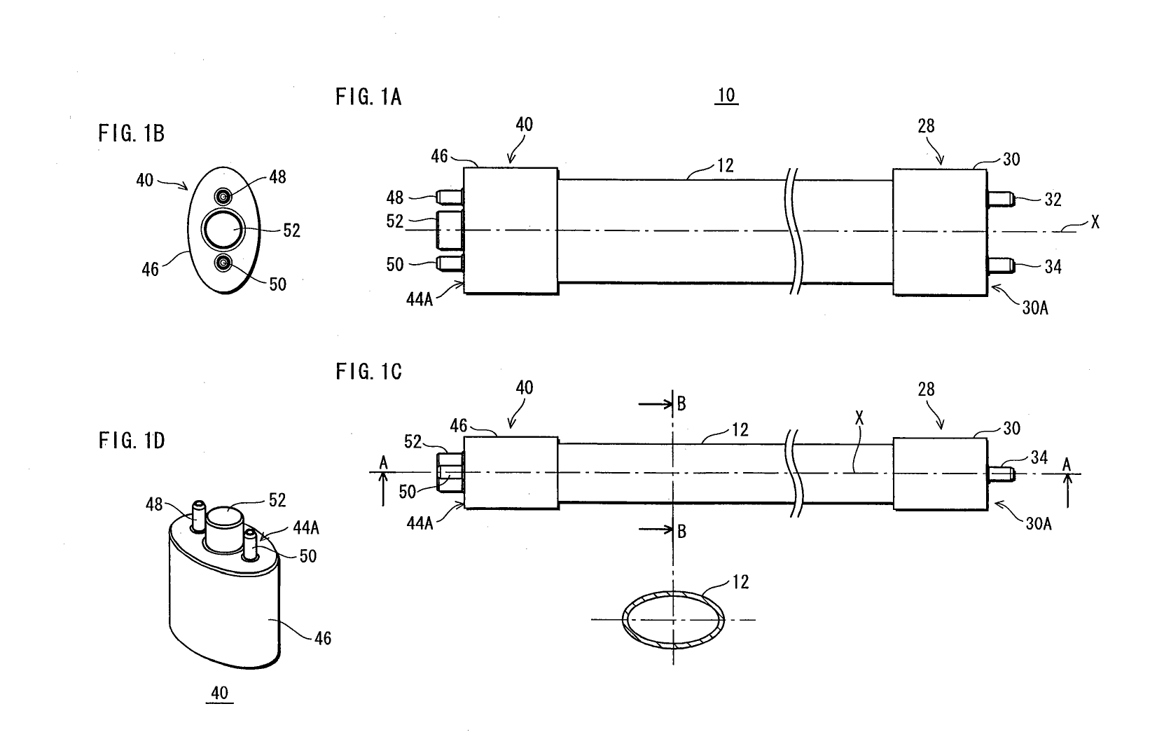

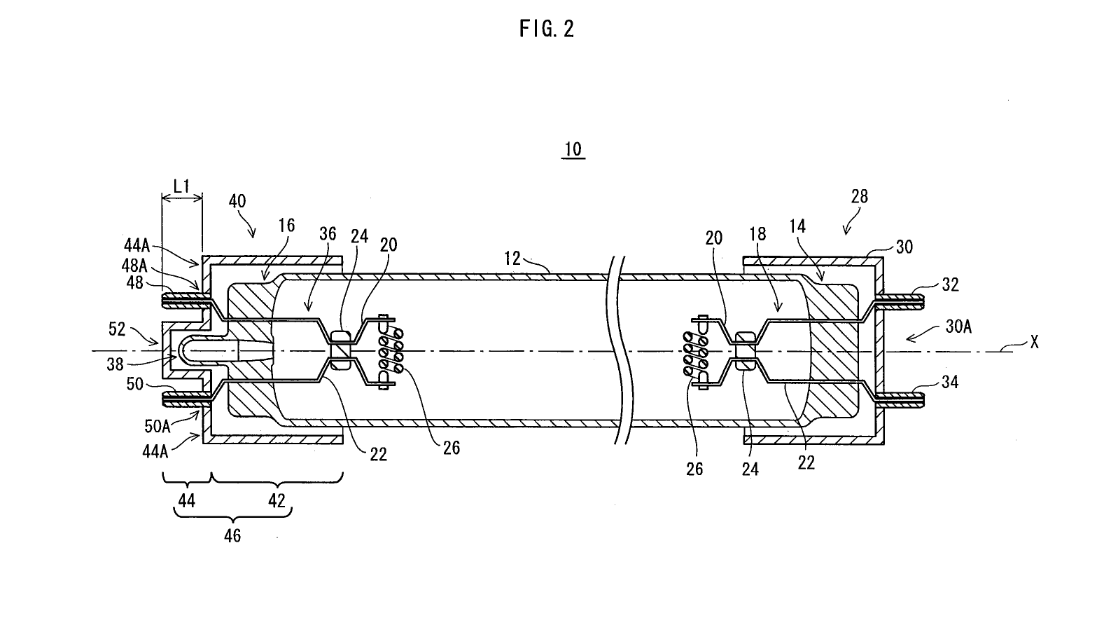

FIG. 1A is a front view of the hot cathode fluorescent lamp 10 (hereinafter simply referred to as “the lamp 10”) pertaining to the present invention. FIG. 1B and FIG. 1C respectively show a left-side view and a bottom view of the lamp 10. FIG. 1D shows a perspective view of a second base 40, which is to be described below. FIG. 2 shows a cross-sectional view of the lamp 10 along the line A-A in FIG. 1C.

As shown in FIG. 1A, FIG. 1B and FIG. 2, the lamp 10 has a soda-lime glass tube 12 whose two opposite ends have been airtight sealed. The glass tube 12 is a straight tube whose cross section has an oval shape as shown in the cross-sectional view along the line B-B in FIG. 1C. The glass tube 12 encloses therein an amalgam to provide mercury vapor, and an argon gas as a rare gas (both not depicted). A phosphor layer (not depicted) is formed on the inner surface of the glass tube 12.

Each of the two opposite ends of the glass tube 12 is pinch sealed. In FIG. 2, the pinch-sealed part on the right-hand side is referred to as “the first sealed part 14”, and the other pinch-sealed part on the left-hand side is referred to as “the second sealed part 16”.

The first sealed part 14 supports a first and a second lead-in wires 20 and 22 of a first electrode 18.

The first and second lead-in wires 20 and 22 are tied up in a bundle by a glass bead 24 inside of the glass tube 12. The two ends of the first and second lead-in wires 20 and 22 inside of the glass tube 12 are connected via a coil to which an emitter (not depicted) is attached.

The first and second lead-in wires 20 and 22 extend to the outside from the first sealed part 14.

A first base 28 is attached to the end part of the first sealed part 14 of the glass tube 12. The first base 28 has a base body 30 having a bottomed cylindrical shape, and the end part of the first sealed part 14 is capped by the base body 30. The base body 30 is made from an insulating material, such as a synthetic resin, selected from PET, PBT, PES, PPS or the like. The base body 30 is bonded to the glass tube 12 with a silicon resin or cement (not depicted).

A pair of hollow base pins, namely a first base pin 32 and a second base pin 34, is implanted on a bottom 30A of the base body 30 in substantially parallel with the axis of the glass tube 12. The first and the second base pins 32 and 34 are made of metal such as copper alloy.

A part of the first lead-in wire 20 extends to the outside from the glass tube 12, and this extending part of the first lead-in wire 20 is inserted into the first base pin 32. The first lead-in wire 20 and the first base pin 32 are connected electrically with each other by solder (not illustrated) filled in the hollow space of the first base pin 32. The second lead-in wire 22 and the second base pin 34 are also electrically connected with each other in the same way as above. Note that the solder filling is not the only way to realize the electrical connection, and the electrical connection may be realized by swaging of the base pins.

Meanwhile, the second sealed part 16 of the glass tube 12 is equipped with a second electrode 36. Since the second electrode 36 has the identical structure to the first electrode 18, each component of the second electrode 36 is given the same referential number as the first electrode 18, and the description thereof is omitted.

A part of the exhaust tube is left projecting from the second sealed part 16. The exhaust tube was used during manufacturing of the lamp 10 in order to exhaust an air from the glass tube 12. Here, the part of the exhaust tube extending (projecting) from the second sealed part 16 is referred to as “remaining exhaust tube 38”.

The remaining exhaust tube 38 is thinner than the second sealed part 16 (and thinner than the outer diameter of the straight part of the glass tube 12, as a matter of course) and extending (projecting) from the second sealed part 16 in the direction parallel to the tube axis.

A second base 40 is attached to the end part of the second sealed part 16 of the glass tube 12.

The second base 40 includes a base body 46, a first base pin 48 and a second base pin 50. The base body 46 has a bottomed cylindrical shape, and is constituted from a tubular part 42 and a bottom part 44.

The base body 46 has a recess that houses at least a part of the remaining exhaust tube 38 (hereinafter referred to as a “housing part 52”) at the center of the bottom part 44 that includes the tube axis X. The housing part 52 projects in the direction of the tube axis X as if it has been pushed out.

The first base pin 48 and the second base pin 50 are implanted on the bottom part 44 such that the housing part 52 is located between the first and second base pins 48 and 50.

Because of the presence of the housing part 52, an attaching surface 44A, to which the first and second base pins 48 and 50 are attached, can be placed closer to the center of the glass tube 12 in the direction of the tube axis X than the top of the remaining exhaust tube 38. With this structure, it is possible to reduce the entire length of the base (measured in the direction of the tube axis X) by the length “L1” between the attaching surface 44A and the top of the housing part 52.

In other words, the entire length of the base can be reduced if the base body 46 has the shape such that a basal end 48A of the first base pin 48 and a basal end 50A of the second base pin 50 are placed closer to the center of the glass tube 12 in the direction of the tube axis X than the top of the remaining exhaust tube 38.

Note that, although in FIG. 1 and FIG. 2 the first base pin 48, the second base pin 50 and the housing part 52 have the same length from the attaching surface 44A, it is preferable that the first and the second base pins 48 and 50 are shorter than the housing part 52. That is to say, it is preferable that the front ends of the first and second base pins 48 and 50 are closer the center of the glass tube 12 in the direction of the tube axis X compared to the end of the housing part 52. With this structure, it is possible to prevent accidents, such as breakage of the first and second base pins 48 and 50, when the lamp 10 is hit by some obstacle at least in the direction of the tube axis X.

Although not mentioned above, the base body 46 of the second base 40 is made of the same material as that of the first base 28. The first and second base pins 48 and 50 are connected to the first and second lead-in wires 20 and 22 respectively in the same manner as the first base 28 described above. Also, the second base 40 is bonded to the glass tube 12 by a silicon resin or cement (not depicted) in the same way as the first base 28.

### (Modification)

In the above embodiment, the tubular part 42 of the base body 46 has the oval cylindrical shape in order to conform to the glass tube 12 having the oval cross section. However, the shape of the tubular part (inner circumference) may be changed accordingly depending on the shape of the glass tube to which the base body is attached.

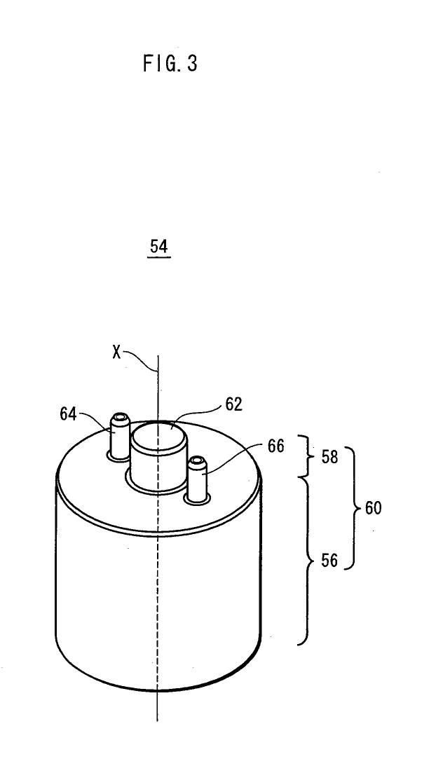

FIG. 3 shows the perspective view of the second base 54 to be attached to a glass tube having the circular cross section.

The second base 54 has a base body 60 that is constituted from a tubular part 56 having a cylindrical shape and a bottom part 58. In the center of the bottom part 58 of the base body 60, a housing part 62 is protruding in the direction of the tube axis X.

A first base pin 64 and a second base pin 66 are implanted on the bottom part 58 in parallel to the tube axis X such that the housing part 62 is located between the first and second base pins 64 and 66.

Note that, in the above embodiment 1 and modification, an engagement claw may be formed on the outer surface of the housing part to be used for fixing the base to a non-depicted socket (needless to say, it is necessary to form an engagement part also on the socket to be engaged with the claw on the housing part). In this case, the engagement claw is easily formed when the housing part has the prismatic shape, instead of the cylindrical shape described in the embodiment 1 and the modification above.

### Embodiment 2

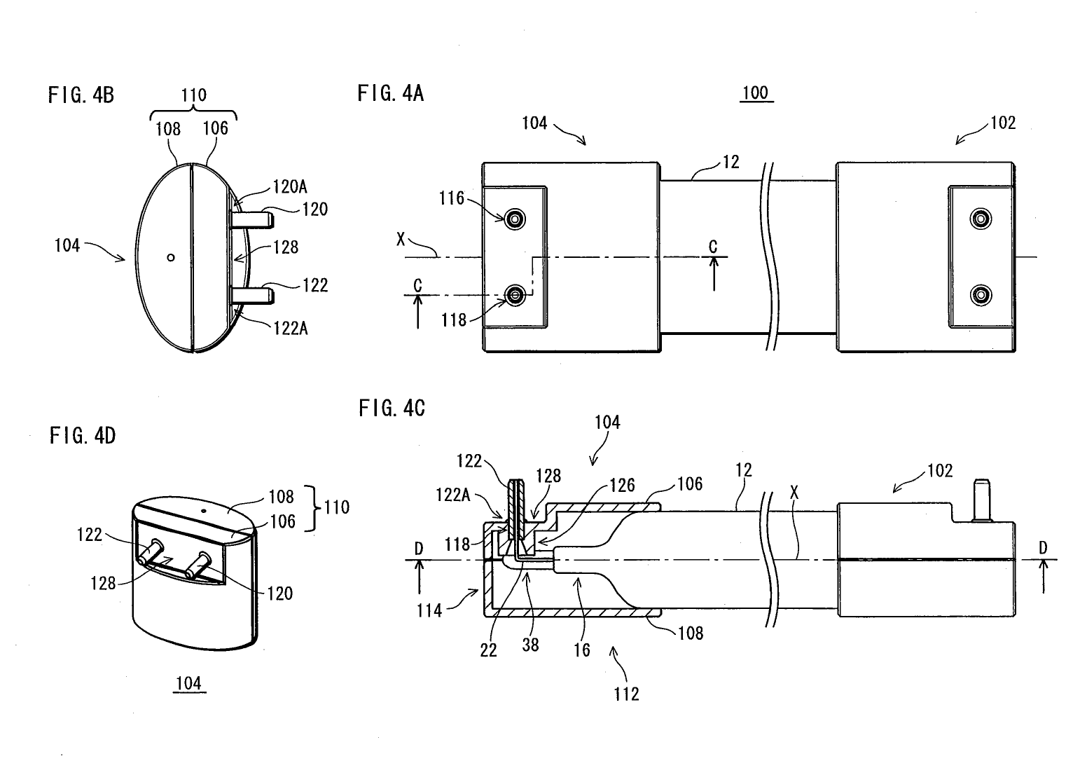

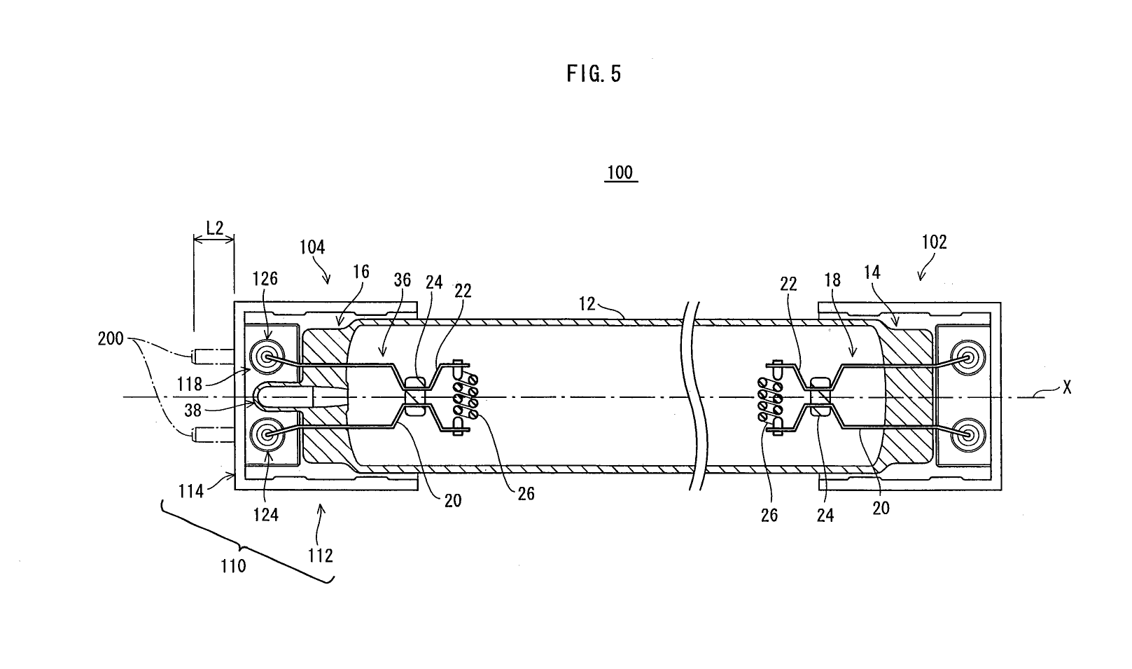

The hot cathode fluorescent lamp 100 (hereinafter simply referred to as “the lamp 100”) pertaining to the embodiment 2 is shown in FIG. 4 and FIG. 5. Basically, the lamp 100 has the same structure as the lamp 10 of the embodiment 1 except for the shape of the bases. Therefore, the components of the lamp 100 that are identical to those of the lamp 10 are given the same referential numbers, and their descriptions are omitted. The following mainly describe the bases.

FIG. 4A, FIG. 4B and FIG. 4C respectively show a front view, a left-side view and a bottom view of the lamp 100. FIG. 4D shows a perspective view of a second base 104 to be described below. Note that FIG. 4C shows a cross section of the second base 104 along the line C-C in FIG. 4A. FIG. 5 shows a cross section along the line D-D in FIG. 4C.

As shown in FIG. 5, a first base 102 is attached to the end of the first sealed part 14 of the glass tube 12, and the second base 104 is attached to the end of the second sealed part 16. In the embodiment 2, the first base 102 and the second base 104 have the identical structure, and hence only the second base 104 is described below.

The second base 104 has a base body 110 that includes a plurality of assembly parts (two in this embodiment, namely a first member 106 and a second member 108). The first member 106 and the second member 108 are separable in the direction that intersects with the tube axis X (in this embodiment, in the direction substantially perpendicular to the tube axis X).

The first member 106 and the second member 108 are assembled by engagement claws (not-depicted). The base body 110 as a result of assembling of the first and second members 106 and 108 has a bottomed cylindrical shape that is constituted from a tubular part 110 and a bottom part 114. Note that the engagement claws are not the only way to assemble the two members, and screws or spring pins etc. may be used to assemble these two members.

On the first member 106, a pair of holes (a first hole 116 and a second hole 118) is provided in the direction intersecting with the tube axis X (in this embodiment, in the direction perpendicular to the tube axis X). The first and second holes 116 and 118 are placed closer to the center of the glass tube 12 than the top of the housing part 38 in the direction of the tube axis. A first base pin 120 and a second base pin 122 are press-fitted into the first hole 116 and the second hole 118 respectively. With this structure, a basal end 120A of the first base pin 120 and a basal end 122A of the second base pin 122 are placed closer to the center of the glass tube 12 than the top of the housing part 38 in the direction of the tube axis X. Needless to say, both of the first and second base pins 120 and 122 are hollow.

The first and second holes 116 and 118 are respectively opened on a first boss part 124 and a second boss part 126. The first boss part 124 and the second boss part 126 swell out in the thickness direction of the tubular part 112. With this structure, press-fit margins can be made for the base pins, and it is possible to implant the base pins stably on the tubular part 112 (on the first member 106).

Also, the first member 106 has a stepped surface 128 that is recessed backward in the direction that intersects with the tube axis X (in this embodiment, in the direction substantially perpendicular to the tube axis). The first and the second base pins 120 and 122 are implanted on the stepped surface 128. With the presence of the stepped surface 128, the second base 104 is attached to a non-depicted socket in such a way that a part of the second base 104 (the stepped surface) and a part of the socket overlap with each other (in the direction perpendicular to the tube axis X). With this structure, it is possible to reduce the thickness of the backlight unit.

The first lead-in wire 20 extending from the second sealed part 16 is bent in the middle at a substantially right angle, and inserted into the first base pin 120. The second lead-in wire 22 is also bent and inserted into the second base pin 122. The first and the second lead-in wires 20 and 22 need to be bent at a substantially right angle to be inserted into the base pins. These lead-in wires are smoothly inserted into the base pins when the inserting is performed before assembling of the first and second members 106 and 108.

As shown in FIG. 4C, the second base 104 is attached to the glass tube 12 such that the open end of the tubular part 112 overlaps with the straight part (non-sealed part) of the glass tube 12. The second base 104 may be attached so as to overlap only with the second sealed part 16. However, if this is the case, the second base 104 is not stably fixed to the glass tube 12 since the shape of the pinch sealed part is not stable. For this reason, in the embodiment, the bases are attached to the glass tube so as to overlap with the straight part of the glass tube whose shape is stable.

Note that the second base 104 is bonded to the glass tube 12 with a silicon or cement (not depicted) in the same way as the embodiment 1.

With the second base 104 having the above structure, the first and second base pins 120 and 122 are implanted in the direction perpendicular to the tube axis X. Because of this, it is possible to reduce the entire length of the base (the length in the direction of the tube axis X) by the length “L2” shown in FIG. 5 compared with the conventional base. Note that a base pin 200 shown with the dashed line in FIG. 5 indicates how the conventional base pin 200 is set up.

Furthermore, in this embodiment, the first and the second base pins 120 and 122 are placed closer to the center of the glass tube 12 in the direction of the tube axis X than the top of the housing part 38. Accordingly, the entire length (in the direction of the tube axis X) of the base body 110 can also be reduced as much as possible.

### (Modification)

In the above embodiment 2, the tubular part 112 of the base body 110 has the oval cylindrical shape so as to conform to the glass tube 12 having the oval cross section. However, in the same way as the embodiment 1, the shape of the tubular part (inner circumference) may be changed accordingly depending on the shape of the glass tube to which the base body is attached.

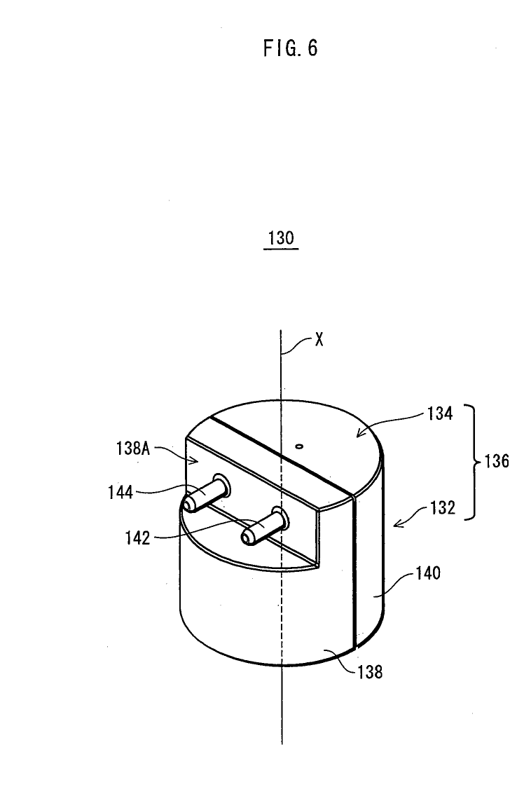

FIG. 6 shows the perspective view of the second base 130 to be attached to the glass tube having the circular cross section. The second base 130 has a base body 136 that is constituted from a tubular part 132 and a bottom part 134. The tubular part 132 has a cylindrical shape near the opening.

The base body 136 is a part constituted from a first member 138 and a second member 140 that are separable in the direction perpendicular to the tube axis X.

The first member 138 has a stepped surface 138A that is recessed backward in the direction substantially perpendicular to the tube axis X. A first and second base pins 142 and 144 are implanted on the stepped surface in the substantially perpendicular direction to the tube axis X.

### Embodiment 3

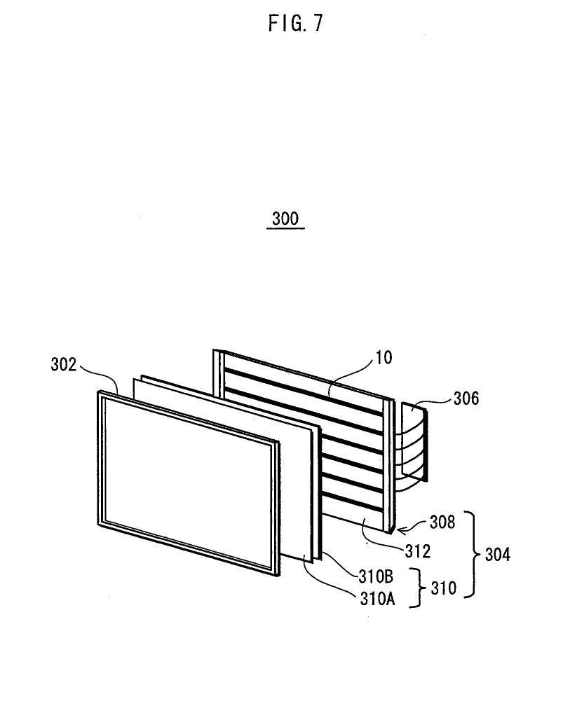

FIG. 7 is an exploded perspective view of the general structure of a liquid crystal display apparatus 300 pertaining to the embodiment 3.

The liquid crystal display apparatus 300 is a 32 [inch] liquid crystal television, for example. As shown in FIG. 7, the liquid crystal display apparatus 300 includes a liquid crystal screen unit 302 having a liquid crystal panel or the like, a lighting circuit 306 and a backlight unit 304 arranged behind the liquid crystal display screen 302.

The liquid crystal screen unit 302 includes the liquid crystal panel (a color filter substrate, liquid crystal, TFT substrate and so on, not depicted) and a driving module etc. (not depicted), and creates a color image based on an external image signal.

The backlight unit 304 is a direct type backlight as shown in FIG. 7, and equipped with a case 308, a plurality of hot cathode fluorescent lamps 10 arranged inside of the case 308, and optical sheets 310 that cover the opening of the case 308 that is adjacent to the liquid crystal screen unit 302.

The case 308 is made from a polyethylene terephthalate (PET) resin, for example. On a surface of a bottom of the case 308, a reflecting surface is formed by deposition of a metal such as silver and aluminum.

The optical sheets 310 are constituted from, for example, a diffusion sheet 310A and a lens sheet 310B.

The lighting circuit 306 causes the fluorescent lamps 10 in the backlight unit 304 to light.

Note that in the above example, the hot cathode discharge lamp 10 pertaining to the embodiment 1 is used as a light source of the backlight unit 304. However, instead of the hot cathode discharge lamp 10 pertaining to the embodiment 1, the hot cathode discharge lamp 100 pertaining to the embodiment 2 may also be used.

So far, the present invention is described based on the embodiments. However it is obvious that the present invention is not limited to the above embodiments, and it is possible to apply other embodiments such as below.
(1) Although the boss parts 124 and 126 (FIG. 4C and FIG. 5) are formed in the embodiment 2 in order to press-fit the base pins, the boss parts may be formed in the embodiment 1.
(2) Although it is preferable that the internal shape of the base body conforms to the external shape of the glass tube to which the base is attached, it is not necessary that the external shape of the base conforms to the external shape of the glass tube. For example, the external shape of the base maybe prismatic or polygonal (including regular polygonal) when the base is attached to the glass tube having a circular or oval cross section.
(3) In the embodiments above, although the base body is made from a resin as an insulator, the base body may be made from a metal. In the case where the base body is made from a metal, the base pin and the base body need be insulated by attaching an insulating sleeve made from a resin or the like to the part where the base pin comes into contact with the base body.
(4) In the embodiments above, although the hot cathode fluorescent lamp is taken as an example, the present invention can be applied to a hot cathode ultraviolet lamp. The hot cathode ultraviolet lamp is used as, for example, a sterilization lamp, and not used as a light source of the backlight unit. However, if the present invention is applied, the hot cathode ultraviolet lamp has an advantage that the entire length thereof can be reduced compared to the conventional lamps.

Note that if the present invention is applied to the hot cathode fluorescent lamp as general lighting or to the base thereof, it is obvious that such lamp also have the advantage of reducing the entire length thereof.
(5) In the embodiments above, the airtight-sealed glass tube has only one remaining exhaust tube left standing out on one of the two ends thereof. However, the present invention can be applied to the glass tube that has two remaining exhaust tubes left on both ends thereof.
(6) In the embodiments above, the glass tube has the straight cylindrical shape. However, the shape of the glass tube is not limited to this. For example, the glass tube may have the shape of “U”, squared “U”, or “N”. In other words, the present invention is suitable to be applied to a lamp regardless of the shape thereof, as long as the lamp's end part ranging from the base to the electrode is hidden behind the frame of the display when the lamp is used as the light source of the backlight unit of the liquid crystal display apparatus.

### INDUSTRIAL APPLICABILITY

The base of the present invention is suitable to be used as, for example, the base to be attached to the hot cathode discharge lamp as the light source of the direct type backlight unit to be incorporated in the liquid crystal display apparatus.

1. A base for attaching to at least one end of a glass tube that has two air-tight sealed ends, the at least one end having a remaining exhaust tube that extends in a tube axis direction of the glass tube, the base comprising:
a base body that is in a shape of a bottomed tube including a tubular part and a bottom part, and receives the at least one end; and
a pair of base pins that have been disposed upright on the base body, wherein
in an attached state, basal ends of the base pins are closer to a center of the glass tube in the tube axis direction than a tip of the remaining exhaust tube.

2. The base of claim 1, wherein
the base body has a housing part that has been disposed in a center of the bottom part so as to project in the tube axis direction, and houses at least part of the remaining exhaust tube, and
the base pins have been disposed upright on the bottom part in substantially parallel to the tube axis direction such that the housing part is located between the base pins.

3. The base of claim 2, wherein
tips of the base pins are closer to the center of the glass tube than a top end of the housing part.

4. The base of claim 1, wherein
the base body has a pair of holes that have been provided in a direction that intersects with the tube axis direction so as to be closer to the center of the glass tube than the tip of the remaining exhaust tube, and
the base pins have been implanted into the holes respectively.

5. The base of claim 4, wherein
the base body has a pair of boss parts that have been formed on the tubular part so as to be raised in a thickness direction of the tubular part,
the holes have been provided in the boss parts respectively, and the basal ends of the base pins have been press-fitted into the holes respectively.

6. The base of claim 4, wherein
the base body is an assembly of at least two members that are separable in the direction that intersects with the tube axis direction, and
the holes have been provided in one of the at least two members.

7. The base of claim 4, wherein
the tubular part has a stepped surface that has been dented in the direction that intersects with the tube axis direction, and
the base pins have been disposed upright on the stepped surface.

8. A base for attaching to at least one end of a glass tube that has two air-tight sealed ends, the at least one end having a remaining exhaust tube that extends in a tube axis direction of the glass tube, the base comprising:
a base body that is in a shape of a bottomed tube including a tubular part and a bottom part, and receives the at least one end; and
a pair of base pins that have been disposed upright on the tubular part in a direction that intersects with the tube axis direction.

9. The base of claim 8, wherein
the base body has a pair of boss parts that have been formed on the tubular part so as to be raised in a thickness direction of the tubular part,
the holes have been provided in the boss parts respectively, and basal ends of the base pins have been press-fitted into the holes respectively.

10. The base of claim 8, wherein
the base body is an assembly of at least two members that are separable in the direction that intersects with the tube axis direction, and
the holes have been provided in one of the at least two members.

11. The base of claim 8, wherein
the base body receives the at least one end of the glass tube such that an open end of the tubular part overlaps a straight part of the glass tube.

12. The base of claim 8, wherein
the tubular part has a stepped surface that has been dented in the direction that intersects with the tube axis direction, and
the base pins have been disposed upright on the stepped surface

13. A hot cathode discharge lamp comprising:
a glass tube that has two air-tight sealed ends, at least one of which has a remaining exhaust tube that extends in a tube axis direction of the glass tube; and
the base of claim 1 that has been attached to the at least one of the two air-tight sealed ends.

14. A liquid crystal display apparatus comprising:
a liquid crystal display panel; and
a backlight unit that has been disposed behind the liquid crystal display panel and has the hot cathode discharge lamp of claim 13 as a light source.
